(19) United States
(12) Patent Application Publication
(10) Pub. No.: US 2018/0067222 A1
(43) Pub. Date: Mar. 8, 2018

(54) MARINE SEISMIC DATA ACQUISITION

(71) Applicant: Fugro N.V., Leidschendam (NL)

(72) Inventor: Angus James Stephen OGILVIE, JR., Aberdeen (GB)

(73) Assignee: Fugro N.V., Leidschendam (NL)

(21) Appl. No.: 15/560,015

(22) PCT Filed: Mar. 29, 2016
(86) PCT No.: PCT/NL2016/050210

§ 371 Date: Sep. 20, 2017

(30) Foreign Application Priority Data
Mar. 26, 2015 (NL) 2014524

(51) Int. Cl. G01V 1/38; G01V 1/387

(52) U.S. Cl. CPC G01V 1/3861; G01V 2210/56; G01V 1/3808; G01V 1/387

(57) ABSTRACT

A marine seismic data acquisition system, comprising: a seismic source arrangement comprising: a first seismic source adapted to be towed at a first predetermined depth and a second seismic source adapted to be towed at a second predetermined depth, which is deeper than the first predetermined depth, wherein, in use, the first seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and the second seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and wherein the first predetermined depth and the magnitude of the peak pressure of the upwardly-travelling pressure wavefield produced by the first seismic source are selected to create an anelastic region at the sea surface having a reflection coefficient of between −0.45 and 0, the system further comprising a receiver for receiving the pulses transmitted from the seismic source arrangement and for extracting data from within a predetermined frequency band of interest.

### FIELD OF TECHNOLOGY

The present invention relates to marine seismic data acquisition. In particular, the present invention relates to a marine seismic data acquisition system, a seismic source arrangement for use in a marine seismic data acquisition system, a method for acquiring marine seismic data and a method for operating a seismic source arrangement in a marine seismic data acquisition system.

### BACKGROUND

In marine seismic data acquisition, one of the phenomena that is encountered that is detrimental to the quality of the acquired data is seismic source ghosting which results from the seismic source being submerged beneath the sea surface. The phenomena of seismic source ghosting is illustrated in FIG. 1, in which a seismic source 20 is shown submerged beneath the sea surface. The seismic source 20 is repeatedly fired generating a plurality of pulses, each pulse comprising a spherical pressure wavefield. Each spherical pressure wavefield has a component, namely the pressure wavefield 41, which travels upwardly and is reflected at the sea/air interface 50, thereby undergoing a downward reflection and a 180° phase shift. Upon reflection, the downwardly-travelling and phase-shifted pressure wavefield is referred to as the ghost pressure wavefield 42. Each spherical pressure wavefield also has a component that travels downwardly towards the seabed and this pressure wavefield is referred to as the primary pressure wavefield 40. The ghost pressure wavefield 42 constructively and destructively interferes with the primary pressure wavefield 40 to form a composite bi-polar pressure wavefield 43 (visible in FIG. 2(c)). As illustrated in FIG. 1, for a portion of the primary pressure wavefield 40 at an angle Θ to the vertical, the corresponding portion of the ghost pressure wavefield 42 is delayed by τ=2d cos (Θ)/c wherein c=the speed of sound in seawater and d=the depth of the transmitter 20. It is the interaction of this composite pressure wavefield 43 with the seabed and with subsequent boundaries between layers under the seabed and its reflection therefrom that provides the data that reveals the structure at and below the seabed.

The interference is detrimental to the quality of the reflected data because it distorts the frequency spectrum of the primary pressure wavefield 40 as is illustrated with reference to FIGS. 2(a-d). A time-domain representation of the amplitude of the primary pressure wavefield 40 is shown in FIG. 2(a) and its spectrum in the frequency domain is shown in FIG. 2(b). A time-domain representation of the amplitude of the composite pressure wavefield 43 comprising the primary pressure wavefield 40 and the ghost pressure wavefield 42 that is delayed, representing a submerged depth of 3 m, and 180° phase-shifted with respect to the primary pressure wavefield 40 is shown in FIG. 2(c) and its spectrum in the frequency domain is shown in FIG. 2(d). Referring to FIG. 2(d), it will be noted that in the frequency spectrum of the composite pressure wavefield there are regions U resulting from constructive interference that are uplifted in comparison with FIG. 2(b) and also a non-zero frequency notch N resulting from destructive interference. The frequency of the non-zero frequency notches depends on the delay τ between the primary and ghost pressure wavefields, which delay, in turn, depends on the depth of the seismic source and the speed of sound in seawater.

U.S. Pat. No. 4,441,174 discloses a seismic source arrangement in which a plurality of sound sources are vertically stacked. The plurality of sound sources are fired so that their outputs combine additively in the downward direct and so as to cause blow out at the sea surface. “Blow out” is a different effect from the shot effect that is exploited by the present invention as is elaborated below.

### SUMMARY

The present invention is concerned generally with mitigating the effect of seismic source ghosting.

According to a first aspect, the present invention provides a marine seismic data acquisition system, comprising:

a seismic source arrangement comprising:

a first seismic source adapted to be towed at a first predetermined depth and a second seismic source adapted to be towed at a second predetermined depth, which is deeper than the first predetermined depth,

wherein, in use, the first seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and the second seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and

wherein the first predetermined depth and the magnitude of the peak pressure of the upwardly-travelling pressure wavefield produced by the first seismic source are selected to create an anelastic region at the sea surface having a reflection coefficient of between −0.45 and 0,

the system further comprising a receiver for receiving the pulses transmitted from the seismic source arrangement and for extracting data from within a predetermined frequency band of interest.

The present invention provides a way of mitigating the effects of seismic source ghosting by driving the sea surface deep into anelastic behaviour thereby creating an anelastic region of low reflectivity. At a reflection coefficient of between −0.45 and 0 i.e. where the energy loss is greater than 55%, the amplitude spectrum of the first seismic source produces sufficient ghost notch in-fill to enable stable deconvolution during data processing/extraction.

Preferably, but not essentially, the second predetermined depth and the magnitude of the peak pressure of the upwardly-travelling pressure wavefield produced by the second seismic source are selected to cause anelastic behaviour at the sea surface, thereby creating a composite anelastic region.

Preferably, the first predetermined depth is selected such that, for the first seismic source, the first non zero frequency notch in the frequency spectrum of its primary pressure wavefield after interference with its ghost pressure wavefield lies outside the predetermined frequency band of interest. By this judicious selection of the system parameters, the above-mentioned first non zero frequency notch is made to have no detrimental effect on the quality of data that the system is able to acquire.

The first and second seismic sources may be vertically aligned or horizontally offset. In a further embodiment, the system may comprise a third seismic source towed at the first predetermined depth, and preferably, the seismic sources are horizontally offset from each other.

According to a second aspect, the present invention provides a seismic source arrangement for use in a marine seismic data acquisition system, comprising:

a first seismic source adapted to be towed at a first predetermined depth and a second seismic source adapted to be towed at a second predetermined depth, which is deeper than the first predetermined depth,

wherein, in use, the first seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and the second seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and

wherein the first predetermined depth and the magnitude of the peak pressure of the upwardly-travelling pressure wavefield produced by the first seismic source are selected to create an anelastic region at the sea surface having a reflection coefficient of between −0.45 and 0.

According to a third aspect, the present invention provides a method for acquiring marine seismic data, wherein a seismic source arrangement comprises a first seismic source and a second seismic source, the method comprising:

towing the first seismic source at a first predetermined depth and towing the second seismic source at a second predetermined depth, wherein the second predetermined depth is deeper than the first predetermined depth;

the first seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield;

the second seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield;

wherein the first predetermined depth and the magnitude of the peak pressure of the upwardly-travelling pressure wavefield produced by the first seismic source are selected to create an anelastic region at the sea surface having a reflection coefficient of between −0.45 and 0, and

the method further comprising receiving the pulses transmitted from the seismic source arrangement and extracting data from within a predetermined frequency band of interest.

According to a fourth aspect, the present invention provides a method for operating a seismic source arrangement in a marine seismic data acquisition system, wherein the seismic source arrangement comprises a first seismic source and a second seismic source, the method comprising:

towing the first seismic source at a first predetermined depth and towing the second seismic source at a second predetermined depth, wherein the second predetermined depth is deeper than the first predetermined depth;

the first seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield;

the second seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield;

wherein the first predetermined depth and the magnitude of the peak pressure of the upwardly-travelling pressure wavefield produced by the first seismic source are selected to create an anelastic region at the sea surface having a reflection coefficient of between −0.45 and 0.

In the context of the present invention, the use of the word “sea” and its related compounds such as “seabed”, “sea surface”, “seawater” and the like are to be construed broadly so as to also encompass contexts in which the expanse of water is not technically a sea; for example, the expanse of water may be an ocean or a lake.

### BRIEF DESCRIPTION OF THE DRAWINGS

Exemplary embodiments of the invention are hereinafter described with reference to the accompanying drawings, in which:

FIG. 1 illustrates the phenomena of seismic source ghosting;

FIGS. 2(a-d) illustrate the distorting effect of the interference from the ghost pressure wavefield on the frequency spectrum of the primary pressure wavefield in the case of a single seismic source;

FIG. 3 shows a schematic view of an embodiment;

FIG. 4 shows a graph showing the approximate minimum zero to peak pressure in bar-m at which anelastic behaviour starts at the sea surface as a function of the depth in m;

FIG. 5 illustrates the shot effect at the sea surface in a first embodiment;

FIG. 6 illustrates the effect of anelasticity at the sea surface on the low frequency end of the spectrum of the composite pressure wavefield from the first seismic source after interference with its ghost pressure wavefield;

FIG. 7 illustrates the effect of anelasticity at the sea surface on the spectrum of the composite pressure wavefield from the second seismic source;

FIG. 8 illustrates the effect of anelasticity at the sea surface on the spectrum of the combined composite pressure wavefield from the first and second seismic sources; and

FIG. 9 illustrates the shot effect at the sea surface in a second embodiment.

### DETAILED DESCRIPTION

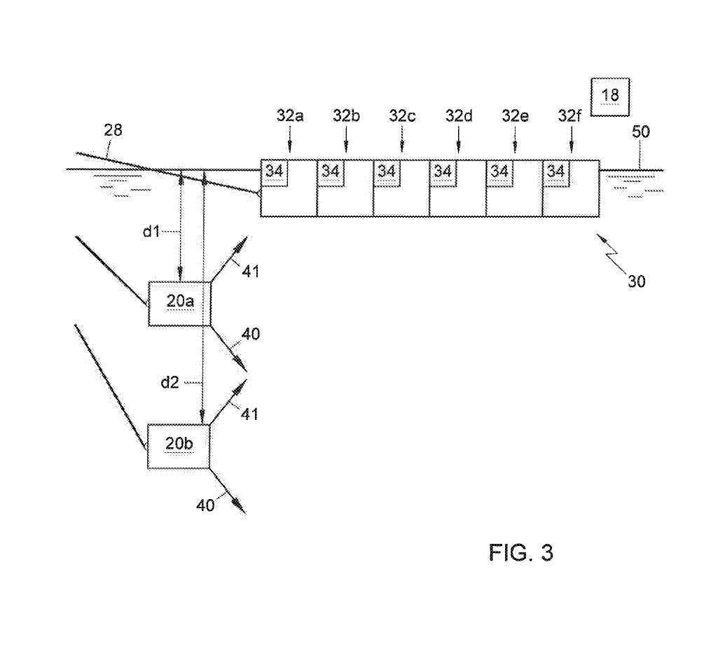

A system 10 for performing marine seismic data acquisition in accordance with a first embodiment of the invention is shown in FIG. 3. The system 10 is a high-resolution system meaning the system parameters, as elaborated below, are set to capture data sub seabed to a depth of about 1 km.

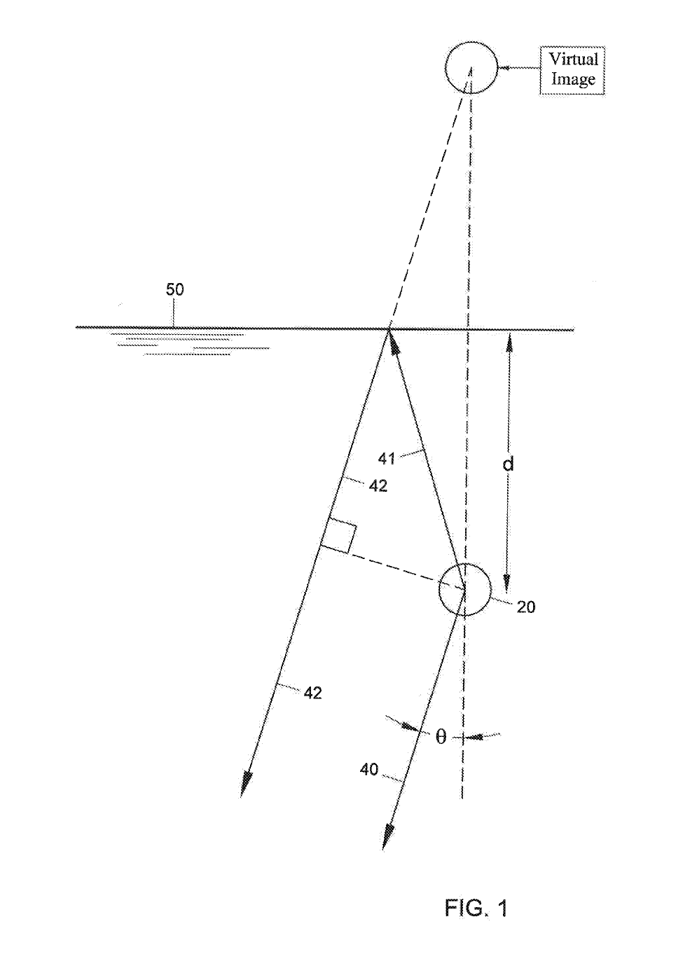

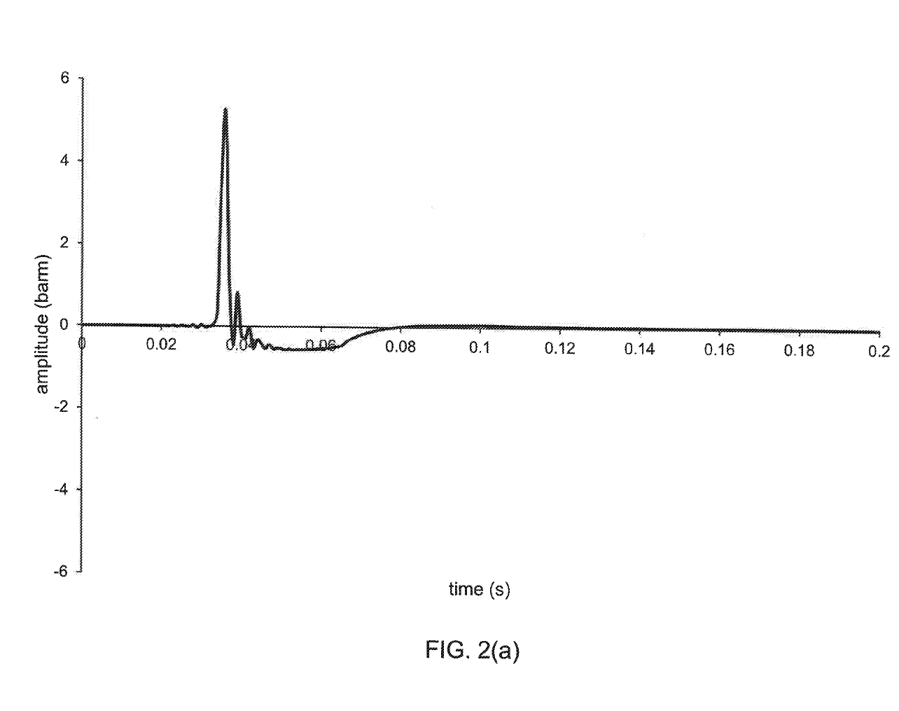

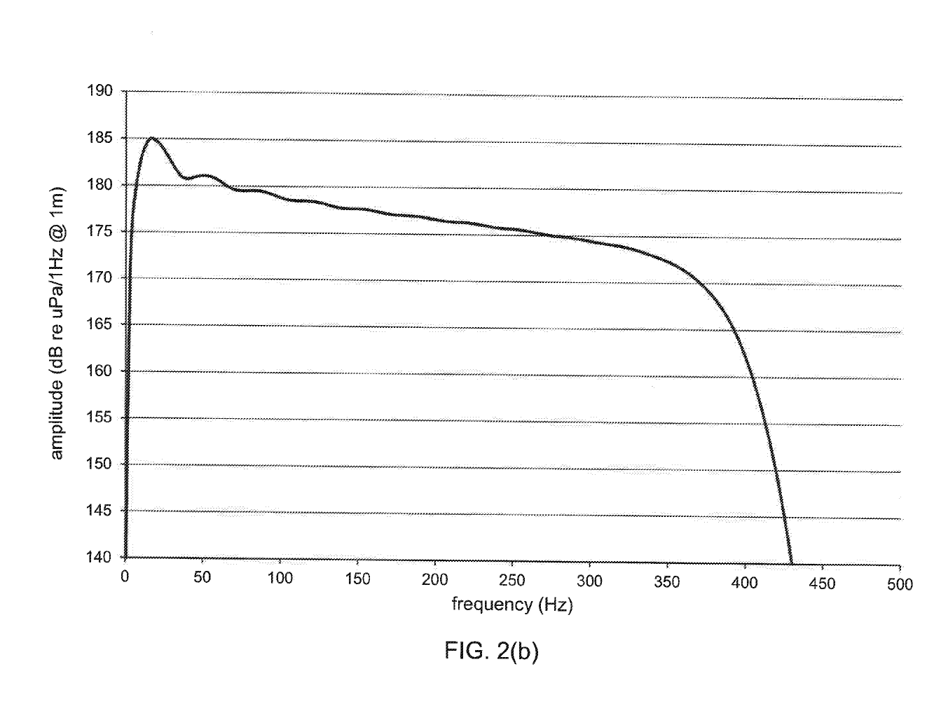

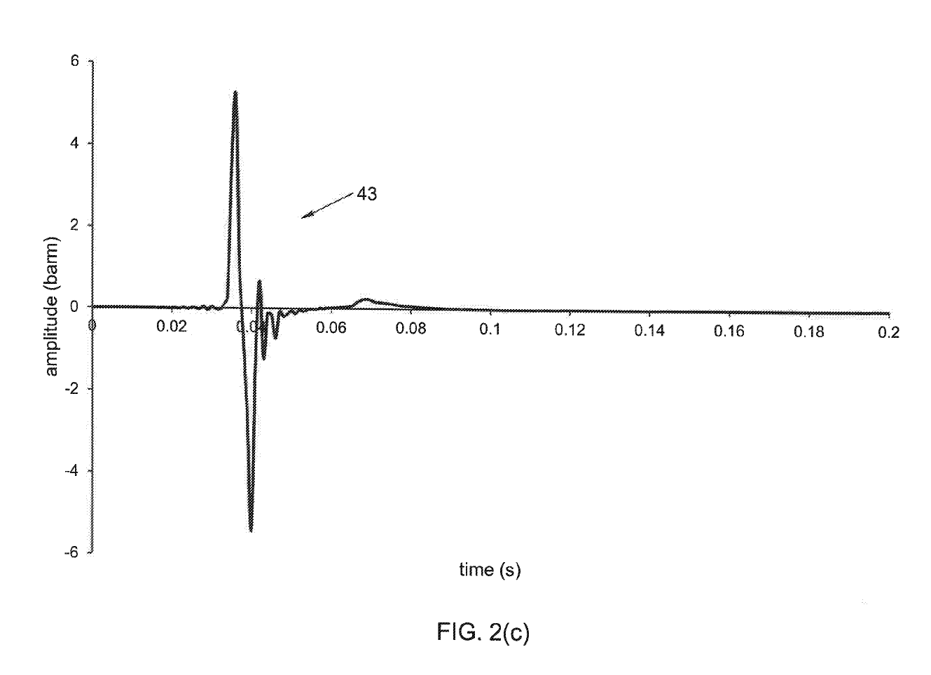

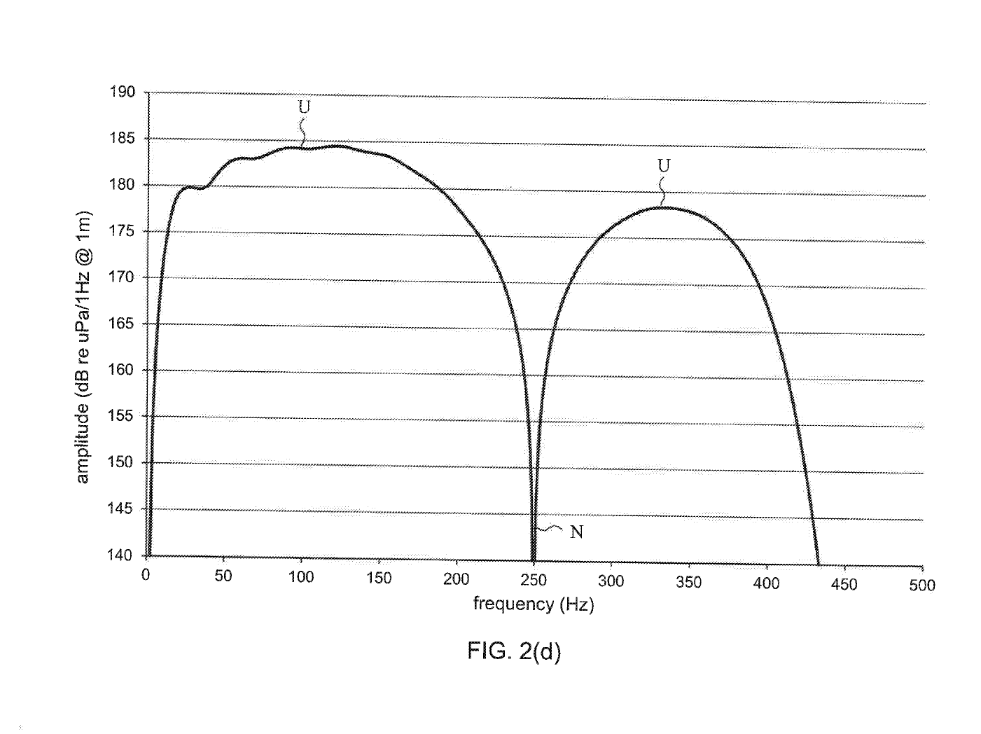

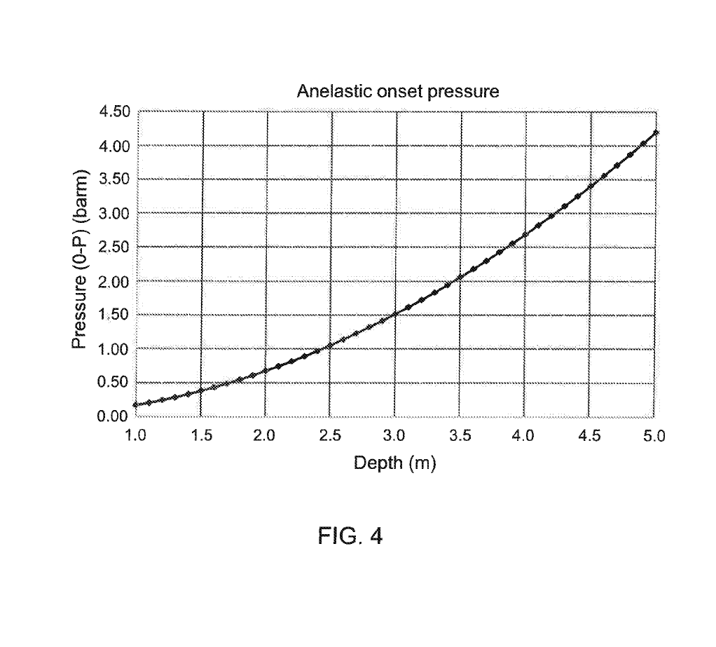

The system comprises a survey vessel (not shown). The system 10 further comprises a first seismic source 20a, for example, in the form of an airgun or airgun array. The first seismic source 20a transmits acoustic pulses or shots with a predetermined period between pulses. In this exemplary embodiment, the pulses are spherical. Each spherical pulse comprises an upwardly-travelling pressure wavefield 41 and a downwardly-travelling primary pressure wavefield 40. As per FIG. 1, the upwardly-travelling pressure wavefield 41 is subsequently reflected at the sea/air interface 50 to become a downwardly-travelling ghost pressure wavefield 42. In this exemplary embodiment of the ghost effect, the pulse is shaped generally as a typical high-resolution seismic source as shown in FIG. 2(a), whereby it has a frequency spectrum as shown in FIG. 2(b). The first seismic source 20a is towed by the survey vessel such that it is submerged at a first predetermined depth d₁ which may, as an example, be d₁=1.5 m. This is a good practical depth since, at this depth, the airguns still operate reliably and the first non zero frequency notch resulting from ghosting is not at 250 Hz as shown in FIG. 2(d) but rather at 500 Hz. In this exemplary system, the frequency band of interest is, as elaborated below, 400 Hz, whereby the notch at 500 Hz sits outside this frequency band of interest. The first seismic source 20a is configured such that its pulses have a magnitude that is sufficient to produce the “shot effect” at the sea surface i.e. to induce anelastic behaviour at the sea surface and thereby create an anelastic region. The effect of an incident pressure wavefield on an anelastically-behaving part of the sea surface is to attenuate the pressure wavefield. This attenuation is speculated to result from the energy that is lost by work done in fracturing the surface in some complex manner. FIG. 4 shows a graph illustrating the approximate minimum zero to peak pressure (0-P) in units of bar-m that anelastic behaviour starts at the sea surface as a function of the depth d in metres. In other words, anelastic effects being to appear whenever the following condition is met:

P≧0.168d² (i)

More information on the shot effect and anelasticity may be found in the paper “An empirical relationship between surface reflection coefficient and source array amplitude” by Les Hatton of Oakwood Computing Associates Ltd. and Kingston University, London of 1 Jan. 2007, which is incorporated herein by reference. In accordance with the invention, an anelastic region that is deeply driven into anelasticity is created with the anelastic region having a reflection coefficient (r) of between −0.45 and 0 where:

r=1.3(P/d²)/^{1/5}−1.7 (ii)

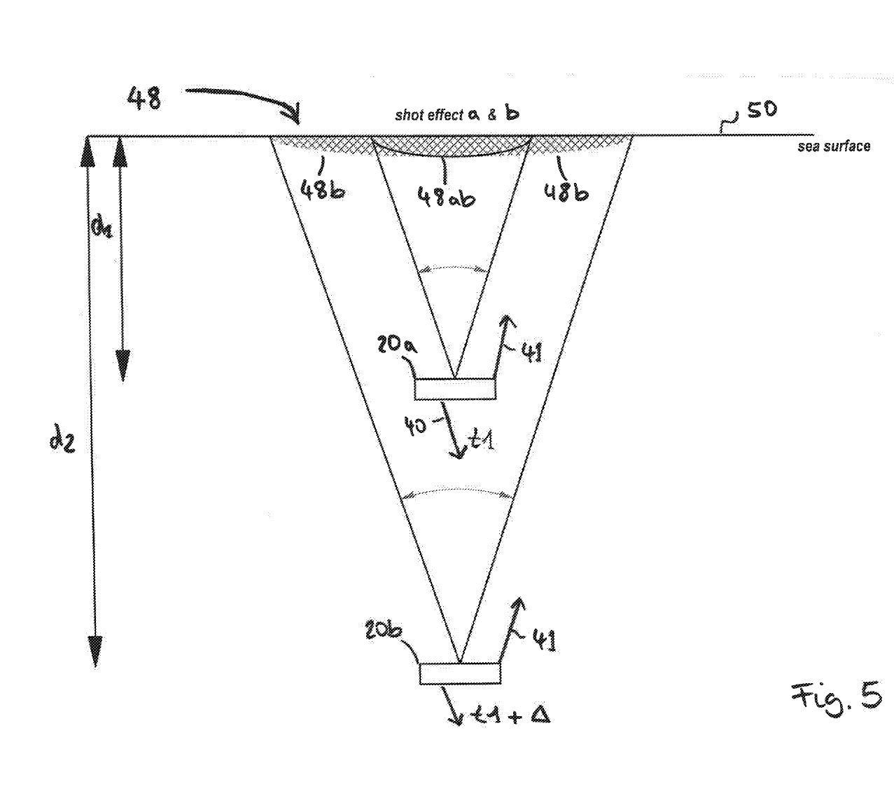

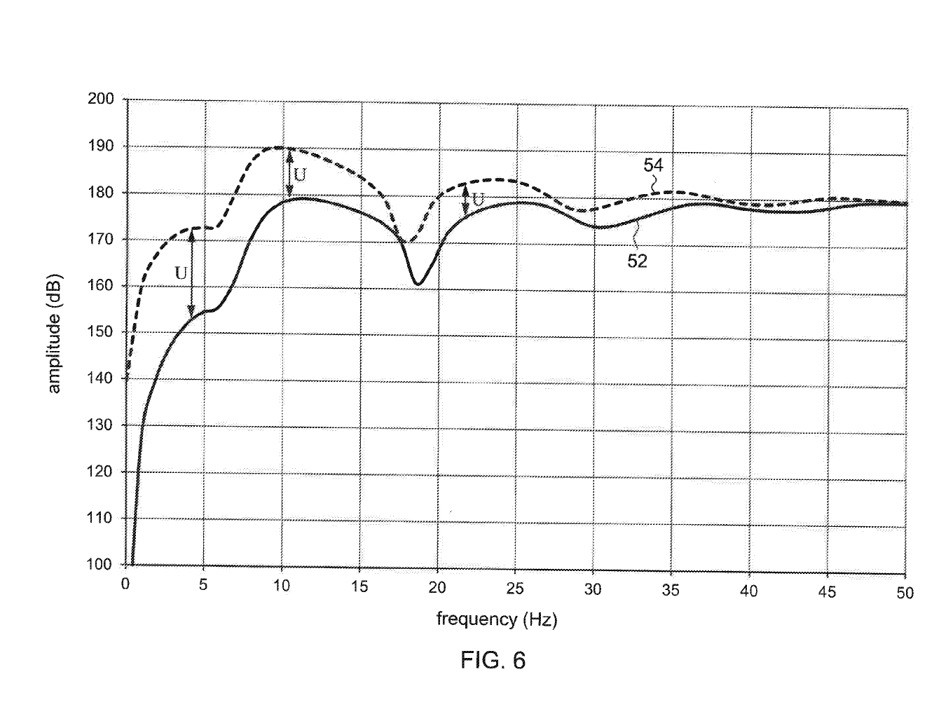

and r is constrained to range (−1.0, −0.3) (−1.0=100% reflection 0% loss, and −0.3=30% reflection 70% loss). A reflection coefficient between −0.45 and 0 (>55% loss) produces in the source amplitude spectrum sufficient ghost notch in-fill to enable stable deconvolution during subsequent data processing. FIG. 6 shows the low frequency end (only) of the frequency spectrum of the primary pressure wavefield from the first seismic source 20a (in isolation) after interference with its ghost pressure wavefield. Reference numeral 52 refers to the frequency spectrum without the sea surface 50 having been driven into anelasticity and reference numeral 54 refers to the frequency spectrum with the sea surface having been deeply driven into anelasticity. The anelasticity effectively reduces the amplitude of the reflected ghost pressure wavefield. It may be seen from FIG. 6 that the effect of the anelasticity at the sea surface is to provide considerable uplift U in the low frequency end of the frequency spectrum which is beneficial to the quality of the signal that can be obtained.

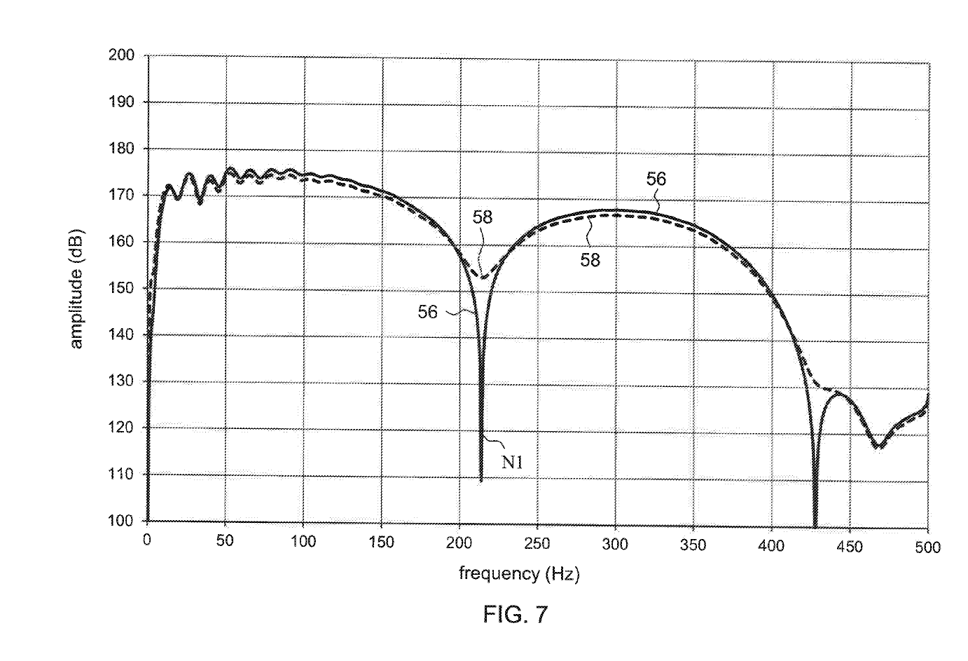

The system 10 further comprises a second seismic source 20b which is also towed by the survey vessel but at a second relatively deep predetermined depth d₂ i.e. where d₂>d₁. In this example, d₂=3.5 m. The second seismic source 20b may transmit the same, or different, shape acoustic pulses or shots with the same predetermined period between pulses as the first seismic source 20a, but the pulses are delayed by a predetermined delay Δ. The predetermined delay Δ is calculated such that the downwardly-travelling primary pressure wavefields of the first and second seismic sources 20a, 20b constructively interfere with each other, thereby creating a combined composite wavefield that is relatively large compared with the ghost pressure wavefield. FIG. 7 shows the frequency spectrum of the primary pressure wavefield from the second seismic source 20b (in isolation) after interference with its ghost pressure wavefield. Reference numeral 56 refers to the frequency spectrum without the sea surface 50 having been driven into anelasticity. It will be noted that due to the destructive interference between the primary pressure wavefield 40 and the ghost pressure wavefield 42 of the second seismic source 20b, a first non zero frequency notch N1 appears at approximately 210 Hz which is within the above-mentioned frequency band of interest of the system 10. Reference numeral 58 refers to the spectrum with the sea surface 50 having been driven anelasticity. The anelasticity effectively reduces the amplitude of the reflected ghost pressure wavefield. It may be seen from FIG. 7 that, in contrast with the case of the shallower first seismic source 20a, the energy at the low frequency end is not uplifted due to anelasticity at the sea surface 50 to the same extent. Moreover, the depth of the first non zero frequency notch is considerably reduced by the effect of anelasticity at the sea surface 50.

Referring back to FIG. 3, the system 10 further comprises a receiver 30 for receiving the pulses transmitted by the first and second seismic sources 20a, 20b. In this exemplary embodiment, the receiver 30 comprises a plurality of sensor groups 32a-f that are mounted on a streamer or cable 28 that is towed by the survey vessel. Each sensor group comprises a plurality of sensors and a local controller 34. The sensors are sensitive to the pressure signature of the first and second seismic sources 20a, 20b. The sensors may be an array of hydrophones. The local controller 34 is operable, treating each sensor as part of a sensor array, to perform a sensor array conditioning operation on the raw reflection data. The sensor array conditioning operation typically comprises summing the data recorded at each sensor within the sensor group. The location of the summed output is assumed to be at the centre of the sensor group. The local controller 34 outputs a data stream of conditioned reflection data for that sensor group. The conditioning operation on the raw reflection data has the effect of cancelling out the relatively large component of the pulse that is received directly from the seismic sources 20a, 20b leaving a composite of the primary pressure wavefields 40 and the ghost pressure wavefields 42. The receiver 30 is configured to extract data from within a predetermined frequency band of interest, which in this example of a high-resolution system is 4-400 Hz. For this frequency band of interest, the sampling rate is lms and the cut-off frequency of the anti-alias filter is set to approximately 400 Hz. In the present embodiment, the sampling and filtering operations are performed within each sensor group 32a-f.

The system 10 further comprises a controller 18 which controls the operation of the first seismic and second sources 20a, 20b, and receives the conditioned reflection data from the receiver 30. Based on the received reflection data, the system 10 generates imaging data of the structure at and below the seabed.

FIG. 5 shows the system 10 in use with the receiver-side of the system 10 omitted for diagrammatic simplicity. The first seismic source 20a transmits a pulse having a magnitude sufficient that its upwardly-travelling pressure wavefield 41 produces the shot effect at the sea surface 50 i.e. to induce anelastic behaviour at the sea surface. It is noted that the shot effect is to be distinguished from the “blow out” effect, for example, described in above-mentioned U.S. Pat. No. 4,441,174. In the case of the shot effect, as is revealed by close observation of the sea surface after a seismic source is fired, a complex disruption of the surface caused by the impact of the direct pressure wave is created. The disruption at the surface is labelled 48 in FIG. 5 and often appears as a thin mist to a depth of several cm punctuated by narrow towers of water of a similar height. This disruption appears almost instantaneously with the small delay corresponding to the distance travelled by the sound wave divided by the speed of sound in seawater. For a typical airgun array, this would correspond to a delay of 4 ms. In contrast, blow out is caused by an after-shock resulting from the firing of an airgun array. The after-shock manifests itself as a spherical bubble with a speed of 1 m/s or so, whereby it appears at the sea surface after several seconds. The second seismic source 20b transmits a pulse which is the same as that of the first seismic source 20a, but delayed by the predetermined delay Δ. The predetermined delay Δ is calculated such that the downwardly-travelling primary pressure wavefields 40 of the first and second seismic sources 20a, 20b constructively/reinforcingly interfere with one another to create a combined primary pressure wavefield. In other embodiments, the seismic sources may be arranged to be fired/triggered with a different time delay. In one embodiment, the seismic sources are fired/triggered simultaneously i.e. with zero time delay.

It is preferred, but not essential, that the magnitude of the pulse of the second seismic source 20b is sufficient such that its upwardly-travelling pressure wavefield 41 produces the shot effect at the sea surface 50. In such a case, the second seismic source 20b contributes to the shot effect in its own right. Indeed, this is the situation illustrated in FIG. 5 in which a composite anelastic region 48 is created. The composite anelastic region 48 comprises a first region 48ab, generated by both the first and second seismic sources 20a, 20b, and two second regions 48b, one on either side of the first region 48ab, generated by the second seismic source. When calculating the output energy from a multi-source system, as per the present example, required to produce an anelastic region having a reflection coefficient (r) which is between −0.45 and 0 in accordance with the present invention, equation (ii) also applies. However, it will be appreciated by the skilled person that, in such cases, p corresponds to the interactive sum of each source's energy output and d is the average of the source depths. In the case that the magnitude of the pulse is insufficient to produce the shot effect in its own right, the upwardly-travelling pressure wavefield 41 is nonetheless attenuated upon reflection at the sea/air interface 50 due to the shot effect created by the first seismic source 20a.

As a consequence of the disruption 48 at the sea surface 50 caused by the shot effect, when the upwardly-travelling pressure wavefields 41 from the first and second seismic sources 20a, 20b are incident on the anelastically-behaving part 48 of the sea surface, energy is lost from the upwardly-travelling pressure wavefields 41, whereby, upon reflection, the ghost pressure wavefields 42 have been attenuated. Thus, the shot effect reduces the energy of the ghost pressure wavefield fields 42 relative to the primary pressure wavefields 40.

As a consequence of the constructive interference between the downwardly-travelling primary pressure wavefields 40 of the first and second seismic sources 20a, 20b, the energy of the primary pressure wavefields is increased relative to the ghost pressure wavefields.

Due to both of these measures, the combined (“interference between the primary pressure wavefields of the first and second seismic sources”) and composite (“interference between the primary pressure wavefield and its respective ghost pressure wavefield”) pressure wavefield has a far greater ratio of primary pressure wavefield energy relative to the ghost pressure wavefield energy as compared with the situation illustrated in FIGS. 1 and 2(a-d). After reflection of the combined and composite pressure wavefield from the seabed, it is received by the receiver 30. The receiver 30 performs the above-described conditioning operation. The receiver 30 then performs anti-alias filtering, sampling and optionally digital filtering to extract the raw reflection data from the predetermined frequency band of interest of the reflected combined and composite wavefield.

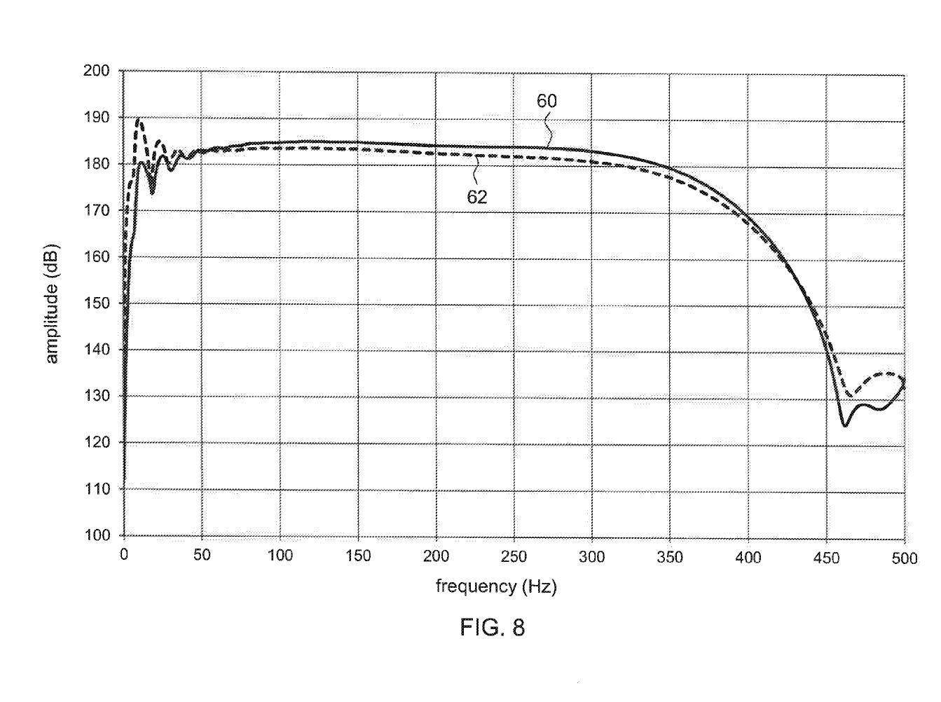

FIG. 8 shows the frequency spectrum of the combined and composite pressure wavefield. Reference numeral 60 refers to the frequency spectrum without the sea surface 50 having been driven into anelasticity. Reference numeral 62 refers to the frequency spectrum with the sea surface having been driven anelastically. Referring to the spectrum 62, it will be appreciated that the above-described embodiment greatly mitigates the effect of seismic source ghosting by virtually eliminating any non zero frequency notches within the bandwidth of interest of the system, while maintaining the low frequency energy of the received signal.

In a variant of the first embodiment (not shown), the first seismic source 20a and the second seismic source 20b are, in addition to being vertically offset as shown in FIG. 5, horizontally offset. In this variant of the first embodiment, it is preferred that the magnitude of the pulse of the second seismic source 20b is sufficient such that its upwardly-travelling pressure wavefield 41 produces the shot effect at the sea surface 50, whereby a composite anelastic region is formed at the sea surface 50. The composite anelastic region comprises a first region generated by the first seismic source 20a, a second region generated by the second seismic source 20b and a third region, between the first and second regions, generated by both the first and second seismic sources 20a, 20b.

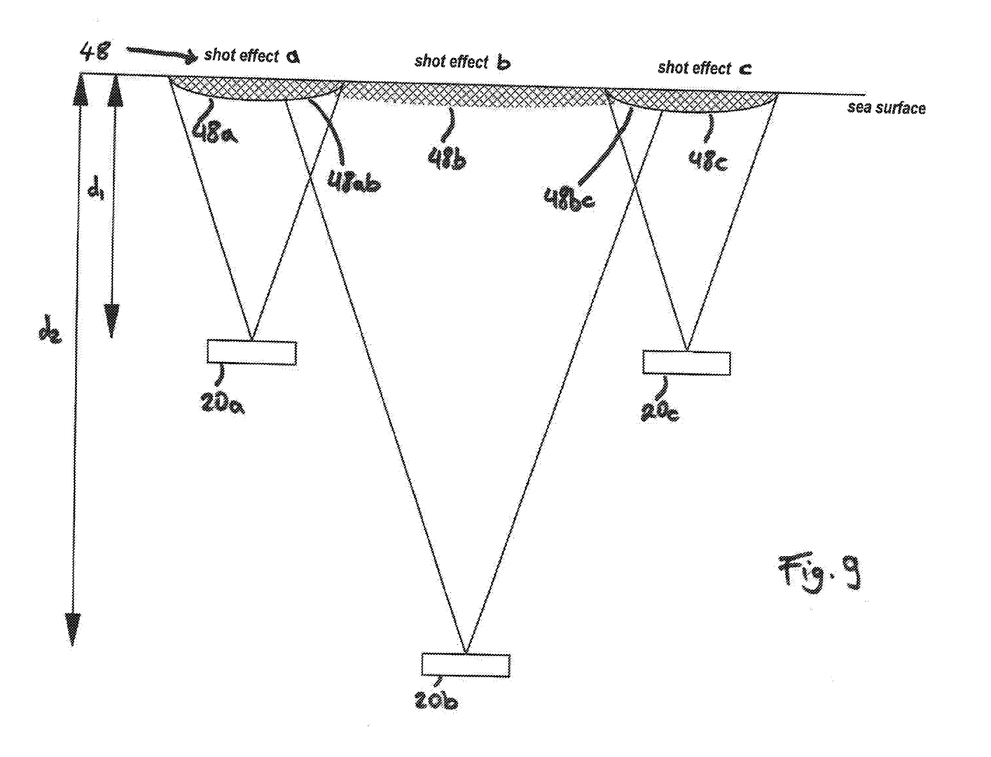

FIG. 9 shows a second embodiment. The second embodiment differs from the first embodiment only in the respects mentioned hereinafter and is otherwise the same. In the second embodiment, in addition to the first and second seismic sources 20a, 20b, the system 10 comprises a third seismic source 20c. The third seismic source 20c is at the same tow depth as the first seismic source 20a, namely the first predetermined depth d1. The seismic sources are horizontally offset with respect to one another with the deeper second seismic source 20b being between the first and third seismic sources 20a, 20c. It is preferred in this embodiment that the magnitude of the pulses generated by each seismic source at its respective depth is sufficient such that its upwardly-travelling pressure wavefield 41 independently produces its own shot effect a, b, c. Due to the horizontal spacing of the seismic sources, this creates a composite anelastic region 48 comprising a first region 48a generated by the first seismic source 20a, a second region 48b generated by the second seismic source 20b, a third region 48c generated by the third seismic source 20c, a fourth region 48ab, extending between the first and second regions 48a, 48b, generated by both the first and second seismic sources 20a, 20b, and a fifth region 48bc, extending between the second and third regions 48b, 48c, generated by both the second and third seismic sources 20b, 20c

The tow depths d₁ and d₂ and the seismic sources 20a, 20b, 20c together with the acoustic output energy of each source are optimized to cause more than 55% acoustic energy loss at the free surface due to anelastic reflection. It has been found by the applicant that the use of three sources arranged as shown in FIG. 9 produces the best compromise in terms of output energy, primary-to-bubble ratio and ghost attenuation and is superior to using either one source or any pair of the three sources 20a, 20b, 20c.

The seismic sources 20a, 20b, 20c may comprise a plurality of airguns, for example, one, two, three or four airguns. The airguns may have a range of airgun volumes. In the second embodiment, each seismic source comprises a clustered pair of airguns. The volumes of each clustered pair range from 12 cubic inch to 40 cubic inch. Such clustered pairs of airguns are also suitable for use in other embodiments.

1. A marine seismic data acquisition system, comprising:
a seismic source arrangement comprising:
a first seismic source adapted to be towed at a first predetermined depth and a second seismic source adapted to be towed at a second predetermined depth, which is deeper than the first predetermined depth,
wherein, in use, the first seismic source transmits pulses, each pulse comprising an upwardly-travelling pressure wavefield, which is reflected at a sea/air interface to become a downwardly-travelling ghost pressure wavefield, and a downwardly-travelling primary pressure wavefield, and the second seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and
wherein the first predetermined depth and a magnitude of the peak pressure of the upwardly-travelling pressure wavefield produced by the first seismic source are selected to create an anelastic region at a sea surface having a reflection coefficient of between −0.45 and 0, and
a receiver for receiving the pulses transmitted from the seismic source arrangement and for extracting data from within a predetermined frequency band of interest.

2. The marine seismic data acquisition system as in claim 1, wherein the second predetermined depth and a magnitude of the peak pressure of the upwardly-travelling pressure wavefield produced by the second seismic source are selected to cause anelastic behaviour at the sea surface, thereby creating a composite anelastic region.

3. The marine seismic data acquisition system as in claim 1, wherein the first predetermined depth is selected such that, for the first seismic source, a first non zero frequency notch in a frequency spectrum of its primary pressure wavefield after interference with its ghost pressure wavefield lies outside the predetermined frequency band of interest i.e. outside a pass-band of the receiver.

4. The marine seismic data acquisition system as in claim 2, wherein the first and second seismic sources are vertically aligned, whereby the composite anelastic region comprises a first region generated by both the first and second seismic sources and two second regions, one on either side of the first region, generated by the second seismic source.

5. The marine seismic data acquisition system as in claim 2, wherein the first and second seismic sources are horizontally offset, whereby the composite anelastic region comprises a first region generated by the first seismic source, a second region generated by the second seismic source and a third region, between the first and second regions, generated by both the first and second seismic sources.

6. The marine seismic data acquisition system as in claim 1, further comprising a third seismic source, adapted to be placed at the first predetermined depth; wherein the seismic sources are horizontally offset with respect to each other with the second seismic source being between the first and third seismic sources, and, in use, the third seismic sources transmits pulses, each pulse comprising an upwardly-travelling pressure wavefield which is reflected at the sea/air interface to become a downwardly-travelling ghost pressure wavefield, and a downwardly-travelling primary pressure wavefield.

7. The marine seismic data acquisition system as in claim 6, wherein a magnitude of pulses generated by each seismic source at its respective depth is sufficient for each upwardly-travelling wavefield to independently cause anelastic behaviour at the sea surface, thereby creating a composite anelastic region.

8. The marine seismic data acquisition system as in claim 7, wherein the composite anelastic region comprises a first region generated by the first seismic source, a second region generated by the second seismic source, a third region generated by the third seismic source, a fourth region, between the first and second regions, generated by both the first and second seismic sources, and a fifth region, between the second and third regions, generated by both the second and third seismic sources.

9. The marine seismic data acquisition system as in claim 1, wherein the first predetermined depth is in the range of 1 m-2 m, and preferably is 1.5 m.

10. The marine seismic data acquisition system as in claim 1, wherein the second predetermined depth is in the range of 3 m-4 m, and preferably is 3.5 m.

11. The marine seismic data acquisition system as in claim 1, wherein at least one of the seismic sources comprises an airgun array in the form of a clustered pair.

12. The marine seismic data acquisition system as in claim 1, wherein the pulses transmitted by at least one of the seismic sources are band limited within a tolerance in frequency of +/−20% to the frequency band of interest of the receiver.

13. (canceled)

14. The marine seismic data acquisition system as in claim 1, wherein the seismic sources are synchronised such that their respective downwardly-travelling pressure wavefields constructively interfere with each other.

15. The marine seismic data acquisition system as in claim 1, wherein the seismic sources are arranged to be fired/triggered simultaneously.

16. A seismic source arrangement for use in a marine seismic data acquisition system, comprising:
a first seismic source adapted to be towed at a first predetermined depth and a second seismic source adapted to be towed at a second predetermined depth, which is deeper than the first predetermined depth,
wherein, in use, the first seismic source transmits pulses, each pulse comprising an upwardly-travelling pressure wavefield, which is reflected at a sea/air interface to become a downwardly-travelling ghost pressure wavefield, and a downwardly-travelling primary pressure wavefield, and the second seismic source transmits pulses, each pulse comprising an upwardly-travelling pressure wavefield, which is reflected at the sea/air interface to become a downwardly-travelling ghost pressure wavefield, and a downwardly-travelling primary pressure wavefield, and
wherein the first predetermined depth and a magnitude of the peak pressure of the upwardly-travelling pressure wavefield produced by the first seismic source are selected to create an anelastic region at the sea surface having a reflection coefficient of between −0.45 and 0.

17. A method for acquiring marine seismic data, wherein a seismic source arrangement comprises a first seismic source and a second seismic source, the method comprising:
towing the first seismic source at a first predetermined depth and towing the second seismic source at a second predetermined depth, wherein the second predetermined depth is deeper than the first predetermined depth;
the first seismic source transmitting pulses, each pulse comprising an upwardly-travelling pressure wavefield, which is reflected at a sea/air interface to become a downwardly-travelling ghost pressure wavefield, and a downwardly-travelling primary pressure wavefield;
the second seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield,
wherein the first predetermined depth and a magnitude of the peak pressure of the upwardly-travelling pressure wavefield produced by the first seismic source are selected to create an anelastic region at a sea surface having a reflection coefficient of between −0.45 and 0; and
receiving the pulses transmitted from the seismic source arrangement and extracting data from within a predetermined frequency band of interest.

18. A method for operating a seismic source arrangement in a marine seismic data acquisition system, wherein the seismic source arrangement comprises a first seismic source and a second seismic source, the method comprising:
towing the first seismic source at a first predetermined depth and towing the second seismic source at a second predetermined depth, wherein the second predetermined depth is deeper than the first predetermined depth;
the first seismic source transmitting pulses, each pulse comprising an upwardly-travelling pressure wavefield, which is reflected at a sea/air interface to become a downwardly-travelling ghost pressure wavefield, and a downwardly-travelling primary pressure wavefield;
the second seismic source transmitting pulses, each pulse comprising an upwardly-travelling pressure wavefield, which is reflected at the sea/air interface to become a downwardly-travelling ghost pressure wavefield, and a downwardly-travelling primary pressure wavefield;
wherein the first predetermined depth and a magnitude of the peak pressure of the upwardly-travelling pressure wavefield produced by the first seismic source are selected to create an anelastic region at a sea surface having a reflection coefficient of between −0.45 and 0.
